(19) United States
(12) Patent Application Publication
(10) Pub. No.: US 2026/0070009 A1
(43) Pub. Date: Mar. 12, 2026

(54) FILTER WITH WASH FLOW BYPASS VALVE

(71) Applicant: Hamilton Sundstrand Corporation, Charlotte, NC (US)

(72) Inventors: Frank Perrelli, East Haven, CT (US); August Coretto, Windsor, CT (US)

(21) Appl. No.: 18/828,396

(22) Filed: Sep. 9, 2024

(51) Int. Cl. B01D 35/147; B01D 29/11; B01D 29/66; B01D 35/00; F02C 7/22

(52) U.S. Cl. CPC B01D 35/1475; B01D 29/11; B01D 29/66; B01D 35/005; F02C 7/22

(57) ABSTRACT

A fuel filtering system comprising a fuel filter having an input, an output and a washing path. The fuel filter may be cylindrical in shape. The system further comprising a bypass valve having an input from the washing path, and a drain, wherein when the cylindrical fuel filter has a pressure drop from the input to the output, the bypass valve opens to permit cleaning of the filter by allowing fuel to flow from the washing path to the drain. The bypass valve comprises a spool, a valve seat and a spring that has a spring rate (Sₖ). The output is may be provide through an input to the bypass valve, behind the spool.

### BACKGROUND

Turbine engines require filtered fuel to operate properly. Normally the system utilizes a fuel filter located at or immediately after the fuel tank. In the event the primary fuel filter becomes either disabled or clogged, a secondary fuel filter may be implemented.

Fluid filters utilized in mechanical systems have existed for some time. There are a number of methods previously utilized to clean the filters when they become clogged. In some applications, variable displacement pumps are used to schedule flow independent of a pressure regulating bypass valve. In these applications supply flow is only generated as needed and results in minimal flow at all other operating conditions. In the case where supply flow needs to be filtered, a barrier screen is the only option when no bypassed flow is present, and this may result in a blockage of the filter. By implementing a passive hydraulic valve that can bypass flow to drain in the event of a clog we can maintain normal filtration operation in the presence of excess contamination.

A traditional system may include a method maintaining wash flow though a continuous bypass. For example, a pressure regulating valve flowing to a drain provides continuous flow that may be used for washing. Variable displacement pumps are designed to output flow optimally for all conditions, if we create a bypass path that can be passively opened based on the wash screens delta pressure, we can protect downstream systems without introducing additional flow under normal operation.

### SUMMARY

There is a need in the industry to increase the amount of filtered fuel available in a system. The current state of the art systems require a large percentage of fuel flow to maintain a clean filter. There is a need in the industry for a system that cleans the filter when necessary and seals the washing path when the filter does not require cleaning. An improved fuel filter wash flow bypass valve is provided which permits cleaning of the fuel filter when the pressure drop across the fuel filter reaches a predetermined value. The fuel filter system, has a filter, with an input, an output, and a washing flow. The filter may be a cylinder, wherein in standard operation, fuel enters the inner diameter of the filter and passes through the outer diameter. The system may also operate with the fuel entering the outside of the filter and passing through to the inner diameter. Pressure drops across the filter occurs as the filter becomes clogged resulting in a pressure differential between the inlet and the outlet of the filter. As the filter builds up from particulates filtered out of the fuel, the pressure drop across the filter increases as Pi becomes greater than Po. This may also result in a drop in the fuel flow across the filter.

A bypass valve has a spool, that seals against a valve seat to prevent fuel flow through the bypass valve. When the pressure drop across the filter increases the bypass valve opens to allow fuel to flow across the filter cleaning the debris. The improved system permits a greater fuel flow by maintaining a clean fuel filter.

### BRIEF DESCRIPTION OF THE DRAWINGS

FIG. 1 shows a schematic view of a fuel system for an aircraft.

FIG. 2A illustrates a prior art fuel filter.

FIG. 2B illustrates a magnified view of the fuel filter of FIG. 1.

FIG. 3 illustrates the improved fuel filter wash flow bypass valve in the closed position.

FIG. 4 illustrates the improved fuel filter wash flow bypass valve in the open position.

FIG. 5 illustrates a second improved fuel filter wash flow bypass valve in the closed position.

FIG. 6 illustrates the second improved fuel filter wash flow bypass valve in the open position.

### DETAILED DESCRIPTION

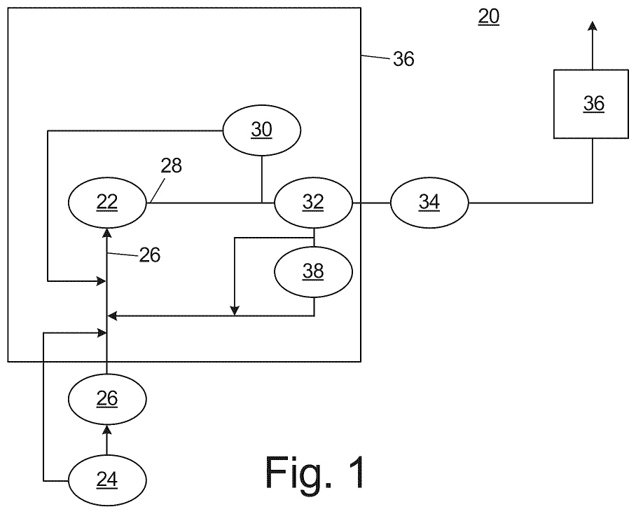

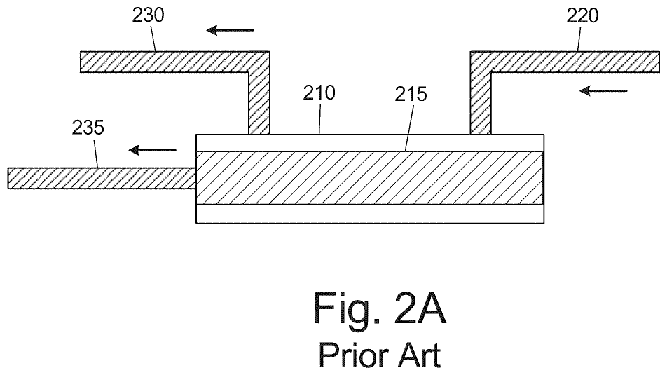

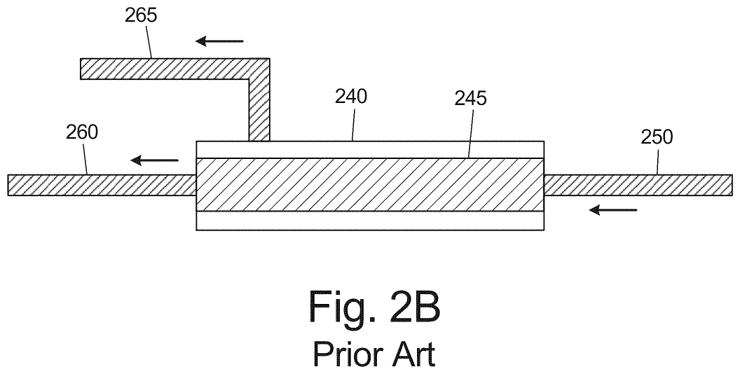

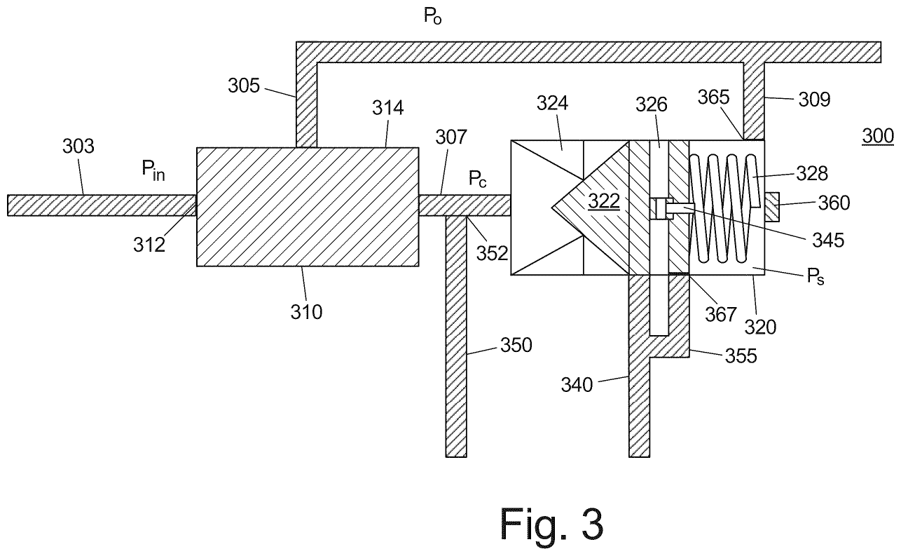

FIG. 1 shows a schematic view of an aircraft fuel supply system 20 incorporating an embodiment of the invention. The fuel supply system 20 has a fuel pump 22 drawing fuel from a fuel supply 24. The pump 22 has a pump inlet 26 in fluid communication with the fuel supply 24 and a pump outlet 28 is in fluid communication with a high pressure relief valve (HPRV) 30. During normal operating conditions the HPRV 30 remains closed and the fuel passes through a filter 32 to remove contaminants. In normal operation fuel exiting the filter 32 is then directed to fuel metering system 34 with a fuel metering valve 36 to supply fuel to an engine and other components. Fuel filter 32 may have an outlet to a bypass valve 38 such as the bypass valve illustrated in FIGS. 3-6. which allows for control of the washing of the filter 32. In prior art systems utilizing fuel filters as illustrated in FIG. 2A & 2B, the bypass valve 38 may not be provided. The fuel that passes through the washing path of filter 32 may be provided back to the pump inlet 26 or an alternative location.

The HPRV 30 is positioned immediately downstream of the pump outlet 28. Should the system 20 become clogged or blocked, the pressure will become undesirably high, which could result in damage to the pump 22. The HPRV 30 will automatically open once a specified pressure level is exceeded to allow fuel to return to the pump inlet 26.

FIG. 2A & 2B illustrate a prior art filter utilized to provide filtered fuel to a system. The prior art filters are no longer viable as the filters require a large percentage of the fuel flowing into the filter for cleaning. As a result the percentage of filtered fuel provided may not meet the needs of the system. FIG. 2A illustrates a filter 210 with an input 220 and an output 230. A second output 235 is also provided. Filter 210 has a filter element 215 which allows for fuel to pass through filter element 215 and out second output 235. Fuel is provided through input 220 to the filter 210 with the majority of fuel passing out output 230. As can be seen by maintaining the flow across filter element 215, the filter will remain clean. However the washing flow required from inlet 220 to outlet 230 may be detrimental to the efficiency of the system if clean fluid 235 at second output 235 is the primary goal, and the washing flow required may be higher than the amount of clean fluid produced.

FIG. 2B illustrates an additional prior art filter configuration. Where the fuel in FIG. 2A was introduced on the outside of the filter element 215, in FIG. 2B the fuel is introduced into the inner circumference of the filter element 245. Filter 240, incorporates a filter element 245 similar to the filter element 215 of FIG. 2A. The filter element may be a tubular metal mesh filter which allows for fuel to pass while preventing the flow of debris. An input 250 to filter 240 may provide fuel into the inner diameter of filter element 245. A first output 260 outputs through the inner diameter of the filter element 245. Cleaned fuel will pass through filter element 245 and out output 265. Again as illustrated above, the washing flow required from inlet 250 to outlet 260 may be detrimental to the efficiency of the system and may be higher than the amount of clean fluid produced. While this may be acceptable for current systems, newer designs require that a larger portion of the fuel be cleaned to provide clean fuel to sensitive systems. As a result new design is required to allow for a larger portion of the fuel to be cleaned.

FIG. 3 illustrates an improved fuel filter wash flow byppass valve in the closed position. The fuel filter system 300, has a filter 310, with an input 303, an output 305, and a washing flow path 307. The filter 310 may be a cylinder, wherein in standard operation, fuel enters the inner diameter 312 of the filter and passes through the outer diameter 314. As filter 310 becomes clogged, pressure at across filter 310 drops resulting in a delta between the pressure at the input Pi and the pressure at the outlet 305 Po. This may be the result of the pressure Pi increasing or Po decreasing or a combination thereof. As filter 310 builds up particulates filtered out of the fuel, the pressure drop across the filter increases as Pi becomes greater than Po. This may also result in a drop in the fuel flow across the filter.

The fuel filter wash flow bypass valve of FIG. 3 further includes a bypass valve 320. Bypass valve 320 comprises a spool 322, that seals against valve seat 324 to prevent fuel flow through the bypass valve 320. Bypass valve 320 is connected to filter 310 through washing flow line 307. Washing flow line 307 is down stream from input 312 and is on the inner diameter 312 of filter 310. The washing flow line 307 is a washing path for filter 310. Wherein when fuel flows in filter 310 across the inner diameter 312 and out washing flow line 307 the inner surface of the filter 310 is cleaned. The greater the fluid flow across the inner surface of filter 310, the greater the cleaning affect on filter 310. While filter 310 in this example is a cylindrical filter with the fuel entering the interior of the cylinder, the filter 310 may be of any filter design that provides an output of filtered liquid while also providing for a washing path to allow for the cleaning of the filter surface.

Bypass valve 320 may be assembled from materials that will support high pressure valves with metal-to-metal seals. One example of an acceptable material is 440 series stainless steel. In another embodiment the seal between spool 322 and valve seat 324 may include an actual face seal element composed of GLT-Viton or PTFE depending on flow rate and pressure drop. Alternatively, the seal may comprise a face seal. A face seal may comprise a gasket between the spool and the valve seat. For a face seal the spool will seal against a flat portion of the valve seal and may incorporate a ring.

The output line 305 provides fuel through input 309 to bypass valve 320 behind spool 322. Input 309 may include an orifice 365 to tune the pressure Ps located behind spool 322. As a result the pressure behind the spool 322 (Ps) may be less than or greater than Po. The pressure resulting behind spool 322 is dependent upon the configuration of bypass valve 320. Spool 322 seals in part due to pressure applied by spring 328 Sk and pressure Ps. As the washing flow path 307 is provided to the input to bypass valve 320, the pressures across the spool equates to Pc*Afront versus Ps*Aback+Sk. As can be seen, when Pc*Afront is greater than Ps*Aback+Sk, then spool 322 opens, allowing fuel to flow across filter 310 cleaning the inner diameter of the filter. When Pc*Afront is less than Ps*Aback+Sk, then spool 322 closes and seals against valve seat 324. The pressure applied by spring 328 to spool 322 is calculated as the spring rate Sk. For discussion purposes, Pc closely follows Pin pressure. Afront is the area of the front of the spool 322 under pressure and Aback is the area of the back of spool 322 receiving pressure Ps. The spring tension Sk is defined as follow as

$$Sk = ( load - initial tension ) / travel$$

Pressures for systems input 312 (Pin) for this system may be on the high pressure side of the system (i.e. Pin may be coming directly from a pump). The pressure coming into the filter 310 may be anywhere from 1000 psig-3000 psig based on legacy systems. However, depending on application the pressure could go higher or lower. The drain 340 may have a pressure generally lower than at coming into filter 310, possibly between 100-300 psig. While these are exemplary pressures for this system, the key to operation is that a pressure delta exist between the input to the filter 310 and the drain 340. When cleaning flow velocity through filter is adequate debris will be carried off of filter and downstream”.

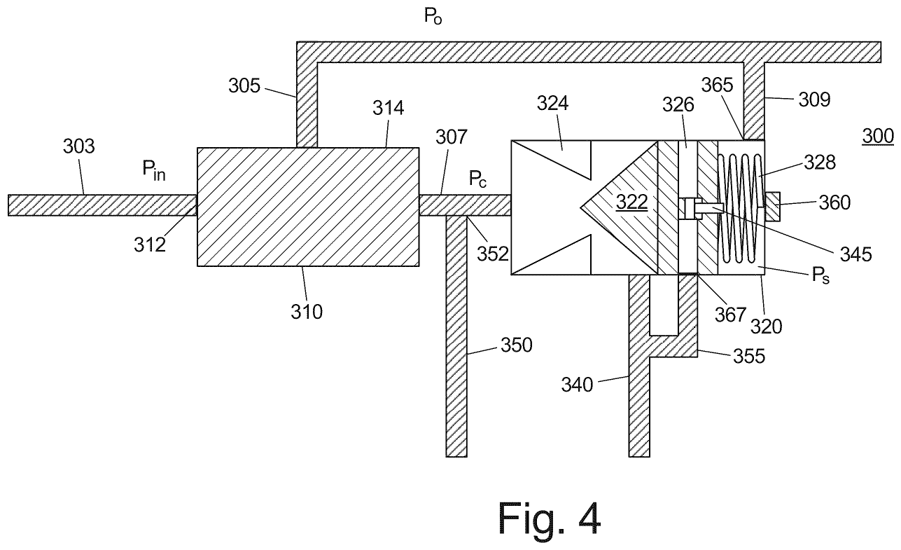

FIG. 4 illustrates spool 322 in an open position. When open, fluid from the washing flow path 307 can pass through bypass valve 320 to drain 340, thus cleaning filter 310. Drain 340 may eject the fluid that passes through it or return the fluid to the input 26 of pump 22 as shown in FIG. 1. Alternatively, drain 340 may discharge to another source provided it has a lower pressure than the input 312. As seen spool 322, further comprises channel 326 and pass through 345. Pass through 345 may allow output fluid from input 309 to pass through spool 322, to channel 326 and exit though drain 355. When in the closed position as seen in FIG. 3, drain 355 is sealed by spool 322.

Drain 355 may also include a second orifice 367 to restrict the flow of fluid into drain 355. A second embodiment would be to size of input 309 through orifice 365 and drain 355 with orifice 367 to ensure pressure behind spool 322 (Ps) drops to keep the spool 322 open. By implementing drain 355 on the back side of the spool 322, the system allows for pressure on the back side of spool 322 (Ps) to drop and maintain Pc>Ps+Sk once the valve opens. When channel 326 is open to drain 355, the delta between Pc and the pressure Ps behind spool 322 may increase to maintain spool 322 in an open position. This may result in spool 322 latching open. Line 309 of FIGS. 3 & 4 may be sized or an orifice 365 may be sized to control the flow of fluid to the back side of spool 322. The drain 355 on the back side of spool 322 is not necessary, however it may add a hysteresis effect which can be tuned. With certain sizing of line 309 and 355, or the inclusion of orifices 365 and 367, it is possible to cause the bypass valve 320 to stay fully open for the duration of a flight. With other sizing the bypass valve 320 would add additional hysteresis. It is possible to make the bypass flow through washing flow path 307 more predictable by latching the bypass valve 320 open. Once the bypass valve 320 is open, it will have the same bypass effective area at all times. If bypass valve 320 is opening and closing, the bypass effective area will be changing.

In another embodiment, the drain 355 of FIGS. 3 & 4 may be omitted. With the removal of the drain 355, the pressure will be regulated through orifice 365 which may result in the pressure Ps plus Sk being greater than Pc. In this embodiment, it is possible that the valve may close when the wash flow is no longer necessary.

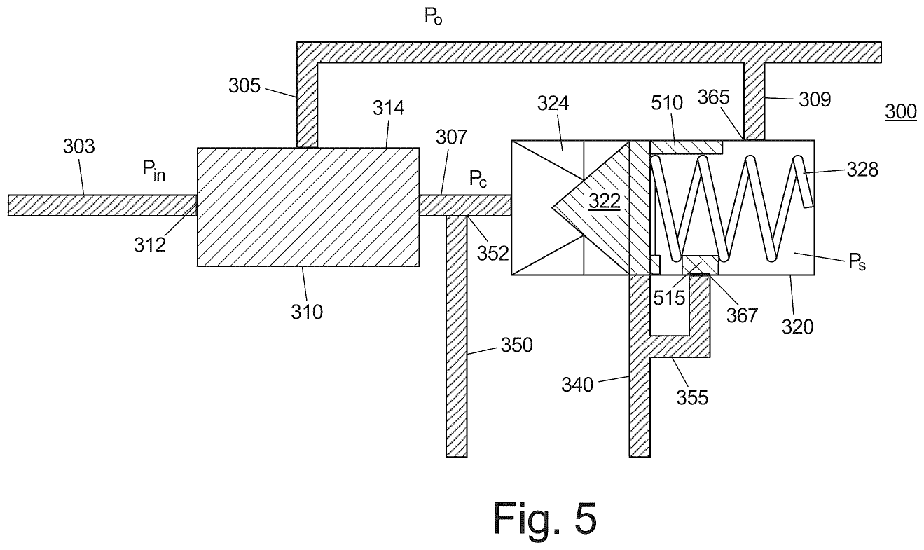

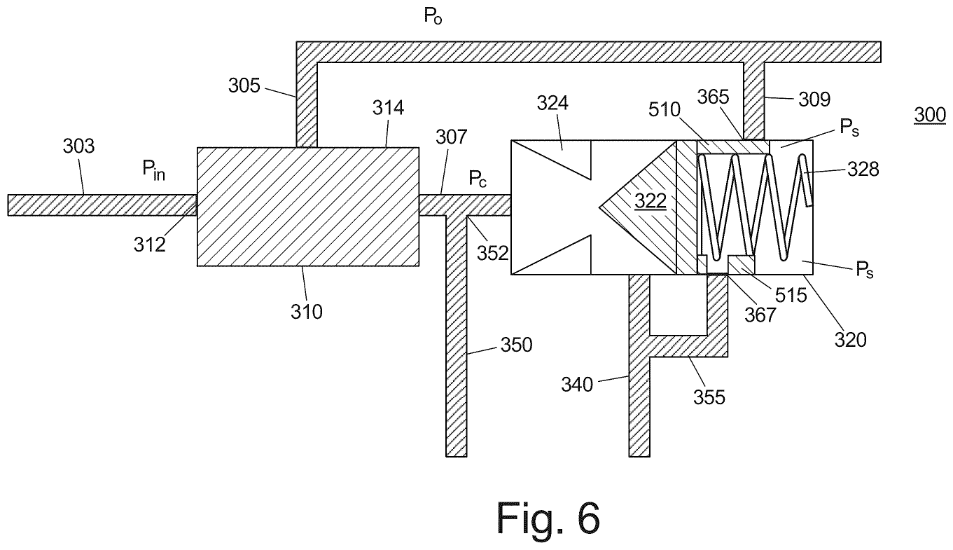

In yet another embodiment as shown in FIGS. 5 & 6 the spool 322 incorporates a sleeve 510 which is able to seal the input 309 to the backside of spool 322 when spool 322 opens. As illustrated in FIG. 5 and FIG. 6, the channel 326 shown in FIG. 3 and FIG. 4 may be eliminated. Spool 322 incorporates a sleeve 510 on the backside of spool 322. The sleeve 510 may be designed such that input 309 is open to the backside of spool 322 when the spool 322 is in a closed position. In addition an output drain 355 may be closed by sleeve 515, when the spool 322 is in a closed position. The sleeve 510 and 515 may be formed as a cylinder on spool 322 or they may be separate elements attached to spool 322.

As shown in FIG. 6, when spool 322 is in an open position, sleeve 510 closes input 309 while sleeve 515 opens to output drain 355. By implementing this embodiment, the system may allow for pressure on the back side of spool 322 (Ps) to drop and Pc>Ps+Sk to remain constant once the valve opens. In this embodiment Ps, behind spool 322 may be lower than Po. The backside of spool 322 is open to drain 355, the delta between Pc and the pressure Ps behind spool 322 is increased to maintain spool 322 in an open position.

The bypass valve may operate in a number of manners. As the pressure drop across filter 310 increases, the spool 322 may open gradually as the ratio of Pc to Po increases, or alternatively, the spool 322 may open completely when Po*Afront>Pc*Aback+Sk. Spring 328 may be adjustable to tune bypass valve 320. To tune spring 328, a tuning screw 360 or other device may be included to tune spring 328. Drain 355 allows for the output flow from input 309 to drain, thus lowering Po at spool 322. As seen in FIGS. 3 & 4, by lowering Po, the spool 322 will remain open longer, in affect creating a hysteresis for spool 322. By tuning the location of channel 326 a “latch open” effect can be enabled, and the size of channel 326 in relation to line 309 can tune the amount of hysteresis effect the valve exhibits. This feature allows additional tuning options but is not necessary for the operation of the valve and in different embodiments this feature may be removed.

By allowing for variable flow through bypass valve 320, it is possible to limit the impact of the washing process. Thus when the filter 310 is blocked, a full flow of the fluid cleans the filter 310 quickly. When the filter 310 does not have as significant a blockage, the bypass valve 320 may not need to open as far, thus reducing flow through washing 307 or the bypass valve 320 may not open for as long a period of time.

In another embodiment, a second drain 350 may be provided to washing flow 307. The second drain 350 may either eject the fluid that passes through it or return the fluid to the input 26 of pump 22 as shown in FIG. 1. Alternatively, drain 340 may discharge to another source provided it has a lower pressure than the input 365. The second drain 350, may be set to allow for constant flow across filter 310. Second drain 350 may incorporate an orifice 352 to limit the flow of fuel through second drain 350.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fuel filtering system comprising:
a fuel filter having an input, an output and a washing path;
a bypass valve having an input from the washing path, and a first drain, wherein the bypass valve is configured such that when the fuel filter has a pressure drop from the input to the output, the bypass valve opens to permit cleaning of the filter by allowing fuel to flow from the washing path to the first drain.

2. The fuel filtering system of claim 1 wherein the bypass valve comprises a spool, a valve seat and a spring that has a spring rate (Sₖ).

3. The fuel filtering system of claim 2 wherein a second input to the bypass valve is adapted to receive the output, behind the spool.

4. The fuel filtering system of claim 3, wherein the bypass valve is configured that when a pressure at the input (P_{c}*Afront), a pressure behind the spool (Pₒ*Aback), and the spring exhibits a force (Sₖ), wherein the bypass valve opens with P_{c}*Afront>Pₒ*Aback+Sₖ.

5. The fuel filtering system of claim 4, wherein the bypass valve has a second drain behind the spool.

6. The fuel filtering system of claim 5 wherein the second drain is closed by the bypass valve when the bypass valve is closed.

7. The fuel filtering system of claim 4, wherein the fuel filter is cylindrical.

8. The fuel filtering system of claim 4 wherein when Pc*Afront<Po*Aback+Sk, the bypass valve is closed.

9. The fuel filtering system of claim 4, wherein the bypass valve opens an amount related to the delta between Pc*Afront and Po*Aback+Sk.

10. The fuel filtering system of claim 2, wherein the spring rate is tunable.

11. The fuel filtering system of claim 3, wherein the second input to the bypass valve is tunable by sizing an orifice at the second input.

12. The fuel filtering system of claim 5, wherein the second output is tunable by sizing an orifice at the output.

13. The fuel filtering system of claim 1 further comprising a seal, wherein the spool seals against the spool when the bypass valve is closed.

14. The fuel filtering system of claim 13, wherein the seal comprises metal.

15. The fuel filtering system of claim 13, wherein the seal comprises a face seal.

16. The fuel filtering system of claim 15 wherein the seal comprises a gasket on the face seal.

17. The fuel filtering system of claim 10, wherein the spring rate is set to limit the opening of the spool.

18. The fuel filtering system of claim 3, wherein the spool seals the input to the bypass valve when the spool is in an open position.

19. A fuel filtering system of claim 6, wherein when the spool opens, the spool remains open until fuel flow through the filter input is reduced.
